(19) United States
(12) Patent Application Publication
(10) Pub. No.: US 2013/0015628 A1
(43) Pub. Date: Jan. 17, 2013

(54) Slider with improved traction system

(71) Applicant: Joseph Lin, Torrance, CA (US)

(72) Inventor: Joseph Lin, Torrance, CA (US)

(21) Appl. No.: 13/135,833

(22) Filed: Jul. 15, 2011

(51) Int. Cl. B62B 13/00

(52) U.S. Cl. 280/18

(57) ABSTRACT

A slider has a board that has a bottom surface, a top surface, a front edge, a rear edge and two side edges. A single recessed longitudinal channel is provided in the bottom surface and extends continuously from the front edge to the rear edge in a manner that divides the bottom surface into two separate longitudinal sections on either side of the channel. The channel is defined by two opposing curved longitudinal surfaces that configure the channel in a manner where the channel is wider at the front edge and the rear edge than at the center of the channel

### BACKGROUND OF THE INVENTION

1. Field of the Invention

The present invention relates to a slider that can be used as a body board, a snow board, a grass sliding board, a sand sliding board, or other board.

2. Description of the Prior Art

Traditional sliders have been used as snow boards, and have increased in popularity as more and more people are seeking snow-related outdoor activities. Examples of such traditional sliders are illustrated in U.S. Pat. No. 6,988,920 (Yeh) and U.S. Pat. No. 4,850,913 (Szabad, Jr.). U.S. Pat. No. 5,275,860 (D'Luzansky et al.) and U.S. Pat. No. 5,114,370 (Moran) illustrate body boards that can be used for water sports.

All of these known sliders and body boards are essentially provided in the form of a simple board having a generally flat upper surface and a generally flat and smooth lower surface. One reason why these sliders have a generally flat and smooth lower surface is because these sliders are typically made by laminating one or more layers of material (e.g., polyethylene) on to a foam core. As a result, it is very difficult and expensive to form a lower surface having a shape and a surface that is anything other than flat and smooth.

When these sliders are used as snow boards, the flat and smooth lower surface provides little friction or resistance, so that the user is not able to control or maneuver the slider. As a result, these sliders tend to spin in the snow if an unexpected force is imparted on to any part of the slider. As another result, the user positioned on and moving with the slider is unable to turn or otherwise maneuver the slider.

Therefore, there still remains a need for a slider that overcomes the drawbacks set forth above.

### SUMMARY OF THE DISCLOSURE

It is an object of the present invention to provide a slider that allows the user to control and maneuver the slider during use.

It is another object of the present invention to provide a slider that has a traction system provided on its bottom surface for allowing the user to control and maneuver the slider during use.

In order to accomplish the objects of the present invention, the present invention provides a slider having a board that has a bottom surface, a top surface, a front edge, a rear edge and two side edges. A single recessed longitudinal channel is provided in the bottom surface and extends continuously from the front edge to the rear edge in a manner that divides the bottom surface into two separate longitudinal sections on either side of the channel. The channel is defined by two opposing curved longitudinal surfaces that configure the channel in a manner where the channel is wider at the front edge and the rear edge than at the center of the channel.

### BRIEF DESCRIPTION OF THE DRAWINGS

FIG. 1 is a bottom perspective view of a snow slider according to one embodiment of the present invention.

FIG. 2 is a top plan view of the slider of FIG. 1.

FIG. 3 is a front plan view of the slider of FIG. 1.

FIG. 4 illustrates the different layers of the slider of FIG. 2.

FIG. 5 is a rear plan view of the slider of FIG. 1.

FIG. 6 is a side plan view of the slider of FIG. 1.

FIG. 7 is a bottom plan view of the slider of FIG. 1 illustrating the flow of the snow through the channel.

FIG. 8 is a bottom perspective view of a water slider according to one embodiment of the present invention.

FIG. 9 is a top plan view of the slider of FIG. 8.

FIG. 10 is a front plan view of the slider of FIG. 8.

FIG. 11 is a rear plan view of the slider of FIG. 8.

FIG. 12 is a side plan view of the slider of FIG. 8.

FIG. 13 is a bottom plan view of the slider of FIG. 8 illustrating the flow of the water through the channel.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

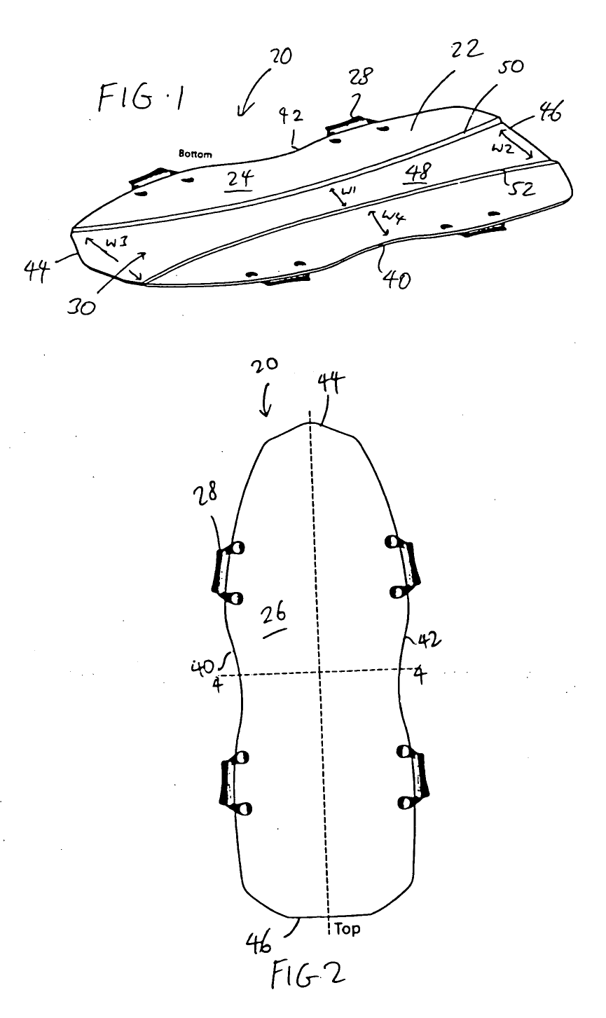

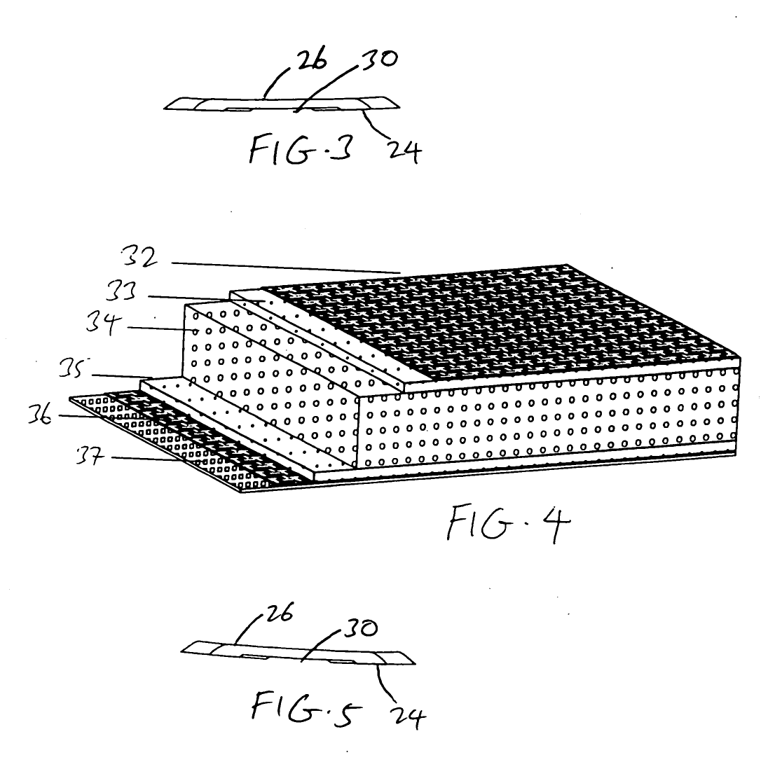

FIGS. 1-7 illustrate a snow slider 20 which has a board 22 which includes a bottom surface 24 and a top surface 26. Handles 28 can be provided in the board 22 at any desired location to act as handles. The board 22 can be provided in any shape or size.

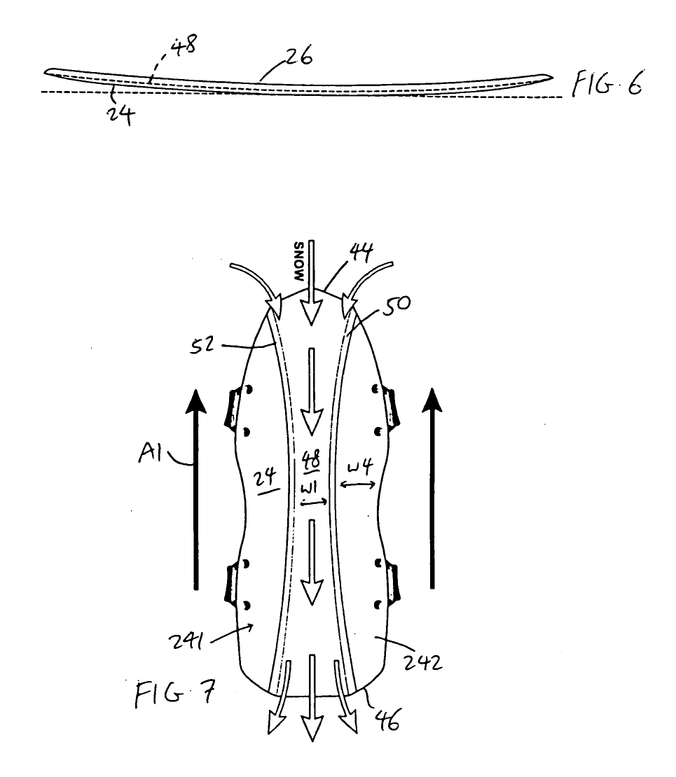

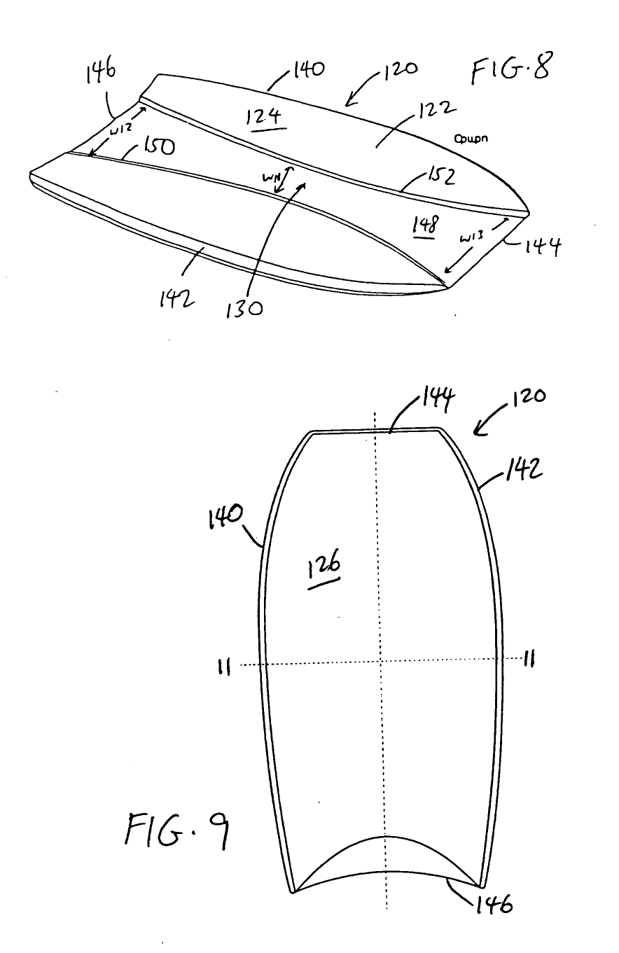

Referring to FIG. 4, the board 22 can be made up of a first layer 32, a second layer 33, a third layer 34, a fourth layer 35, a fifth layer 36 and a sixth layer 37 that are a laminated together, from top to bottom, in this order. The first layer 32 can be a polyethylene film having a thickness between 0.03 mm and 0.06 mm. The second layer 33 can be a polyethylene (PE) skin of low-density polyethylene (LDPE) or cross-polyethylene (XPE) material having a thickness between 1 mm and 5 mm. The third layer 34 is essentially the core of the board 22, and is preferably a LDPE material having a density between 30 KG to 60 KG per 1 m³. Since the third layer 34 is essentially the core of the board 22, it can have any desired thickness depending on how thick the board 22 is intended to be. The fourth layer 35 is preferably a LDPE or XPE material having a thickness between 1 mm and 5 mm. The fifth layer 36 can be a polyethylene film having a thickness between 0.03 mm and 0.06 mm. The sixth layer 37 is a mixture of a LDPE and a high density polyethylene (HDPE) that has been extruded together, and having a thickness between 0.3 mm and 0.8 mm. The LDPE can be 30% of the mixture, with the HDPE being 70% of the mixture, or the HDPE can be 30% of the mixture, with the LDPE being 70% of the mixture. Thus, if the mixture includes more HDPE, the sixth layer 37 will be made of a harder material than if the mixture includes more LDPE.

As non-limiting examples, a HDPE material according to the present invention would have a specific gravity of less than 0.94, while a LDPE material according to the present invention would have a specific gravity of 0.94 or more.

The density of the material of the second layer 33 is preferably greater than the density of the material for the third layer 34, and can have the same or greater density than the material for the fourth layer 35. The density of the material of the fourth layer 35 is preferably greater than the density of the material for the third layer 34. In other words, the density of the material for the third layer 34 is the smallest because the third layer 34 acts as the core. In addition, the density of the material for the sixth layer 37 is greater than the densities of the materials for the other layers 32, 33, 34, 35, 36 because the sixth layer 37 represents the bottom of the board 22 and therefore needs to be stronger.

The board 22 can have two side edges 40 and 42, a front edge 44, and a rear edge 46. The board 22 can be formed according to the following process:

1. The sixth layer 37 is formed by a liquid extrusion process.

2. The bottom-facing surface of the fifth layer 36 is heat laminated to the upper-facing surface of the sixth layer 37. This can be accomplished by applying (e.g., sticking) the fifth layer 36 to the sixth layer 37 while the sixth layer 37 is still wet from its liquid extrusion, and then allowing the layers 36 and 37 to dry and bond together.

3. The fourth layer 35 is heat laminated to the fifth layer 36.

4. The combined fourth, fifth and sixth layers 35, 36 and 37 are then heat laminated with the third layer 34 in a heat-compression mold. Specifically, the bottom-facing surface of the third layer 34 is heat laminated to the upper-facing surface of the fourth layer 35. The mold is formed in any desired shape, and is therefore used to shape the board 22.

5. The layers 34, 35, 36 and 37 are the heat-pressed in the mold to form the desired product shape.

6. The first layer 32 is heat laminated to the second layer 33.

7. The mold is then opened, and the combined first and second layers 32 and 33 are placed into the mold and heat-pressed on top of the upper-facing layer of the third layer 34.

8. The mold is opened and excess material is trimmed away from the edges.

The molding of the layers 34+35+36+37 to the layers 32+33 allows the board 22 to be formed with any desired cross-sectional shape. For example, as shown in FIGS. 1-7, the board 22 can be formed to have a generally concave top surface 26 and a generally convex bottom surface 24, and with a recessed channel 30 extending through the entire length from the front edge 44 to the rear edge 46. The concavity and convexity in the surfaces 26 and 24, respectively, extend from the front edge 44 to the rear edge 46, and from one side edge 40 to the other side edge 42. In addition, the degree of the concavity and convexity in the surfaces 26 and 24, respectively, can be very small so that the board 22 appears to be generally flat and planar.

A traction system can be provided on the bottom surface 24 of the board 22 to allow the user to control and maneuver the slider 20 during use. The traction system comprises the single channel 30 that is recessed from the bottom surface 24. As best seen in FIGS. 1, 3, 5 and 7, the channel 30 extends longitudinally through the approximate center of the board 22, and divides the bottom surface 24 of the board 22 into two separate longitudinal sections 241 and 242. The channel 30 has a slightly curved top surface 48, and curved transition surfaces 50 and 52 that extend between the top surface 48 and the bottom surface 24 of the board 22 in a manner that define parabolic surfaces. These transition surfaces 50, 52 can be angled so provide for a smooth transition between the top surface 48 and the bottom surface 24 of the board 22. The channel 30 begins at the front edge 44 and ends at the rear edge 46.

The channel 30 has a widened area W3 at the front edge 44 that gradually narrows to a narrowed width W1 adjacent the center of the channel 30, and then gradually widens to another widened area W2 at the rear edge 46. Thus, the channel 30 has its narrowest width at the center, and is widest at the front edge 44 and the rear edge 46. The width W1 is preferably about one-third of the entire width of the board 22, the width W2 can be about 40-50% of the entire width of the board 22, and the width W3 can be a greater percentage (e.g., more than 50%) of the entire width of the board 22 to facilitate more effective channeling or diversion of snow into the channel 30. In addition, the channel 30 can have a uniform depth throughout, and the depth can be about 10% to 30% of the thickness of the entire board 22.

Thus, the bottom of the board 22 is configured to provide a parabolic shape that operates similar to a hydrofoil. This parabolic shape helps the user to control the movement of the slider 20, including forward movement, speed and turns. As shown in FIG. 7, as the slider 20 slides forwardly (see arrows A1), the snow is directed into the channel 30 from the front edge 44, and the channel 30 functions to divert or direction the snow through the middle of the slider 20, and to exit the channel 30 at the rear edge 46. With the force of the snow passing through the middle of the slider 20, the user can maintain better control of the slider 20 by minimizing spinning, so as to keep the slider 20 moving forward in a steady and stable manner. The raised area of the channel 30 means that there is minimal surface area in contact with the snow (similar to an aerofoil boat concept), thereby creating less drag to facilitate higher speeds. The curvature of the transition surfaces 50, 52 allows the board 22 to turn in the direction of the curvature.

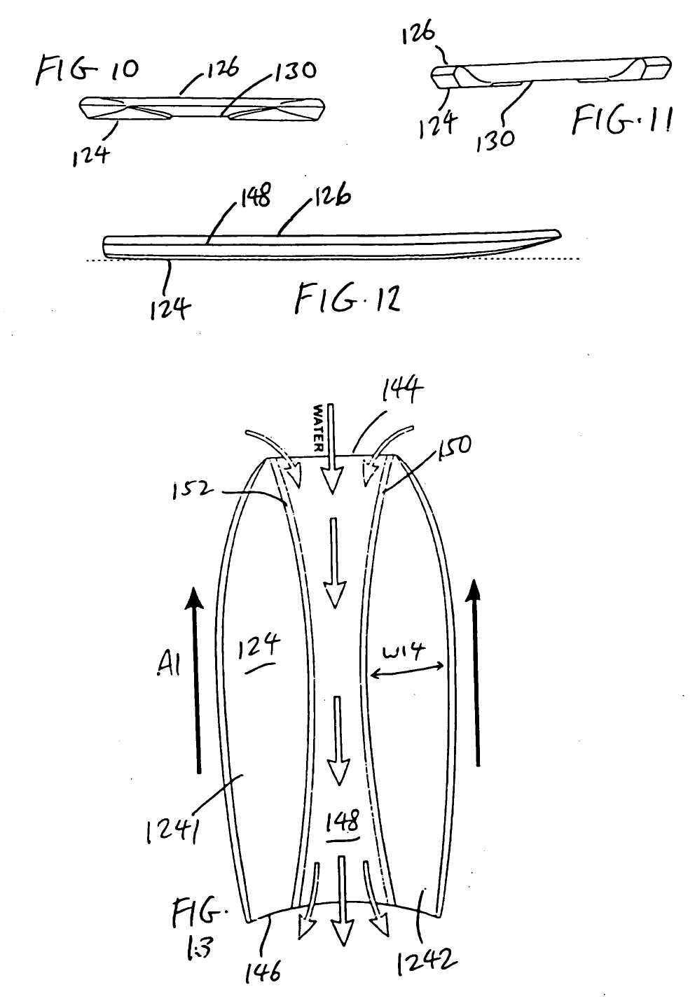

FIGS. 8-13 illustrate a water slider 120 which has a board 122 which includes a bottom surface 124 and a top surface 126. The board 122 can be provided in any shape or size. The water slider 120 can have the same construction as the snow slider 20, and made in the same manner as described above, except that the size and configuration of the overall board 122 can be different. One possible difference is that the second layer 33 can have a different thickness (e.g., between 2 mm and 8 mm) and act as a polyethylene (PE) deck.

The board 122 can be formed to have a generally flat or planar top surface 126 and a generally flat or planar bottom surface 124, and with a recessed channel 130 extending through the entire length from the front edge 144 to the rear edge 146. A traction system can be provided on the bottom surface 124 of the board 122 to allow the user to control and maneuver the slider 120 during use. The traction system comprises the single channel 130 that is recessed from the bottom surface 124. As best seen in FIGS. 8, 10, 11 and 13, the channel 130 extends longitudinally through the approximate center of the board 122, and divides the bottom surface 124 of the board 122 into two separate longitudinal sections 1241 and 1242. The channel 130 has a flat or planar top surface 148, and curved transition surfaces 150 and 152 that extend between the top surface 148 and the bottom surface 124 of the board 122 in a manner that define parabolic surfaces. These transition surfaces 150, 152 can be angled so provide for a smooth transition between the top surface 148 and the bottom surface 124 of the board 122. The channel 130 begins at the front edge 144 and ends at the rear edge 146.

The channel 130 has a widened area W13 at the front edge 144 that gradually narrows to a narrowed width W11 adjacent the center of the channel 130, and then gradually widens to another widened area W12 at the rear edge 146. Thus, the channel 130 has its narrowest width at the center, and is widest at the front edge 144 and the rear edge 146. The width W11 is preferably about one-third of the entire width of the board 122, the width W12 can be about 40-50% of the entire width of the board 122, and the width W13 can be a greater percentage (e.g., more than 50%) of the entire width of the board 122 to facilitate more effective channeling or diversion of snow into the channel 130. In addition, the channel 130 can have a uniform depth throughout, and the depth can be about 10% to 30% of the thickness of the entire board 122.

Thus, the bottom of the board 122 is configured to provide a parabolic shape that operates similar to a hydrofoil. This parabolic shape helps the user to control the movement of the slider 120, including forward movement, speed and turns. As shown in FIG. 13, as the slider 120 slides forwardly (see arrows A1), the water enters the channel 130 from the front edge 144, and the channel 130 functions to divert or direction the water through the middle of the slider 120, and to exit the channel 130 at the rear edge 146. With the force of the water passing through the middle of the slider 120, the user can maintain better control of the slider 120 by minimizing spinning, so as to keep the slider 120 moving forward in a steady and stable manner. The raised area of the channel 130 means that there is minimal surface area in contact with the water (similar to an aerofoil boat concept), thereby creating less drag to facilitate higher speeds. The curvature of the transition surfaces 150, 152 allows the board 122 to turn in the direction of the curvature.

The embodiments shown and illustrated in FIGS. 1-13 are of sliders 20 and 120 that do not have any graphics or patterns printed on the bottom surface 24, 124 or the top surface 26, 126. However, graphics can be provided in any manner that is well-known in the art, and examples include those set forth in U.S. Pat. No. 7,430,795, whose disclosure is incorporated by this reference as though set forth fully herein. The graphics can be covered by a protective layer, or not covered by a protective layer (in which case the graphics would be exposed to the environment).

In addition, in the embodiment of FIGS. 1-7, the fifth layer 36 can be omitted, especially when using full color printing graphics shown on the bottom, and in the embodiment of FIGS. 8-13, the first layer 32 can be omitted, such as when using full color printing graphic shown on the top.

While the description above refers to particular embodiments of the present invention, it will be understood that many modifications may be made without departing from the spirit thereof. The accompanying claims are intended to cover such modifications as would fall within the true scope and spirit of the present invention.

What is claimed is:

1. A slider, comprising:
a board that has a bottom surface, a top surface, a front edge, a rear edge and two side edges; and
a single recessed longitudinal channel provided in the bottom surface and extending continuously from the front edge to the rear edge in a manner that divides the bottom surface into two separate longitudinal sections on either side of the channel, the channel defined by two opposing curved longitudinal surfaces that configure the channel in a manner where the channel is wider at the front edge and the rear edge than at the center of the channel.

2. The slider of claim 1, wherein the two opposing curved longitudinal surfaces are angled.

3. The slider of claim 1, wherein the width of the channel is about one-third the width of the board.

4. The slider of claim 1, wherein the depth of the channel is about 10% to 30% the thickness of the board.

5. The slider of claim 1, wherein the depth of the channel is uniform throughout.

6. The slider of claim 1, wherein top and bottom surfaces are slightly curved.

7. The slider of claim 1, wherein top and bottom surfaces are flat.

8. The slider of claim 1, wherein the channel has a flat top surface.

9. The slider of claim 1, wherein the channel has a curved top surface.

10. A slider, comprising:
a board that has a bottom surface, a top surface, a front edge, a rear edge and two side edges; and
a single recessed longitudinal channel provided in the bottom surface and extending continuously from the front edge to the rear edge in a manner that divides the bottom surface into two separate longitudinal sections on either side of the channel, the channel defined by two opposing curved longitudinal surfaces that configure the channel in a manner where the channel is wider at the front edge and the rear edge than at the center of the channel, wherein:
the two opposing curved longitudinal surfaces are angled;
the width of the channel is about one-third the width of the board; and
the depth of the channel is uniform throughout, and is about 10% to 30% of the thickness of the board.

11. The slider of claim 10, wherein top and bottom surfaces are slightly curved.

12. The slider of claim 10, wherein top and bottom surfaces are flat.

13. The slider of claim 10, wherein the channel has a flat top surface.

14. The slider of claim 10, wherein the channel has a curved top surface.

15. A method of controlling a slider on snow or water, comprising the steps of:
a. providing a slider having:
a board that has a bottom surface, a top surface, a front edge, a rear edge and two side edges; and
a single recessed longitudinal channel provided in the bottom surface and extending continuously from the front edge to the rear edge in a manner that divides the bottom surface into two separate longitudinal sections on either side of the channel, the channel defined by two opposing curved longitudinal surfaces that configure the channel in a manner where the channel is wider at the front edge and the rear edge than at the center of the channel;
b. directing snow or water to enter the channel from the front edge; and
c. causing snow or water to exit the channel from the rear edge.
